(19) United States
(12) Patent Application Publication
(10) Pub. No.: US 2015/0070360 A1
(43) Pub. Date: Mar. 12, 2015

(54) METHOD AND MOBILE TERMINAL FOR DRAWING SLIDING TRACE

(71) Applicant: TENCENT TECHNOLOGY (SHENZHEN) COMPANY LIMITED, Shenzhen, GD (CN)

(72) Inventors: Zhiyun Liu, Shenzhen (CN); Guoxiong Lin, Shenzhen (CN); Liang Deng, Shenzhen (CN); Gen Luo, Shenzhen (CN); Maoqing Fu, Shenzhen (CN)

(21) Appl. No.: 14/391,630

(22) PCT Filed: Mar. 15, 2013
(86) PCT No.: PCT/CN2013/072697

§ 371 Date: Oct. 9, 2014

(30) Foreign Application Priority Data
Apr. 9, 2012 (CN) 201210101545.2

(51) Int. Cl. G06T 11/80; G06F 3/0488; G06T 11/20

(52) U.S. Cl. CPC G06T 11/80; G06T 11/203; G06F 3/0488
USPC 345/443

(57) ABSTRACT

Disclosed is a method and mobile terminal for drawing sliding track. The method comprises: A) obtaining the total sliding distance and the total sliding time for sliding from the sliding start position to the sliding end position; B) drawing the sliding track of the current frame image in the sliding start position, recording the current time for finishing the drawing of the current frame image; C) obtaining the drawing time from the drawing start time to the current time for finishing the drawing of the current frame image, judging whether the drawing time is greater than or equal to the total sliding time, if no, performing the step D, if yes, performing the step E; D) according to the drawing time, the total sliding time and the total sliding distance, obtaining the current sliding distance, replacing the sliding start position by the sum of the sliding start position and the current sliding distance, returning to the step B; E) drawing the sliding track of the last frame image in the sliding end position.

### CROSS REFERENCE TO RELATED APPLICATION

The present application is a U.S. National Phase application under 35 U.S.C. §371 of International Application No. PCT/CN2013/072697 filed on Mar. 15, 2013, which claims the priority of Chinese Patent Application No. 2012101015452 filed on Apr. 9, 2012 in the State Intellectual Property Office of the P.R.C., and entitled “METHOD AND MOBILE TERMINAL FOR DRAWING SLIDING TRACE”, and the disclosure of which are incorporated by reference herein in their entirety.

### TECHNICAL FIELD

The present invention relates to a field of Information Technology, and particularly to a method and a mobile terminal for drawing sliding trace.

### BACKGROUND

With the rapid development of Intelligent Mobile Terminal Technology, operators open a new era of touch screens of mobile terminals such as tablet computers or mobile phones or etc.

For a mobile terminal with a touch screen, a sliding operation is an important operation, and the fluency thereof directly affects user experience. The existing mobile intelligent operating systems all provide API (Application Programming Interface) to draw sliding traces via system controls, thereby achieving basic sliding operations.

At present, interactions between intelligent mobile terminal applications become more and more diversified, and users start to desire various sliding interactions. In general, however, such a method for achieving a sliding operation by using the system controls can only address simple sliding requirements and cannot satisfy various sliding interactions due to the fixed sliding time and non-customized sliding actions, thereby reducing the degree of the user experience.

### SUMMARY

In an aspect, a method for drawing a sliding trace is provided, which includes:

A) obtaining an overall sliding distance and overall sliding time from a sliding start location to a sliding termination location;

B) drawing, at the sliding start location, a sliding trace in a current image frame and recording a current time point when the drawing of the current image frame is completed;

C) obtaining drawing time from a drawing start time point to the current time point when the drawing of the current image frame is completed, and determining whether the drawing time is greater than or equal to the overall sliding time; on the condition that the drawing time is less than the overall sliding time, performing step D, and on the condition that the drawing time is greater than or equal to the overall sliding time, performing step E;

D) obtaining a current sliding distance according to the drawing time, the overall sliding time and the overall sliding distance, resetting the sliding start location as the sum of the sliding start location and the current sliding distance, and returning to step B; and

E) drawing, at the sliding termination location, a sliding trace in the last image frame.

In another aspect, a mobile terminal is provided, which includes:

a first obtaining module, adapted for obtaining an overall sliding distance and overall sliding time from a sliding start location to a sliding termination location;

a drawing recording module, adapted for drawing, at the sliding start location, a sliding trace in a current image frame and recording a current time point when the drawing of the current image frame is completed;

a second obtaining module, adapted for obtaining drawing time from a drawing start time point to the current time point when the drawing of the current image frame is completed;

a determination module, adapted for determining whether the drawing time is greater than or equal to the overall sliding time;

a first processing module, adapted for obtaining the current sliding distance according to the drawing time, the overall sliding time and the overall sliding distance on the condition that the drawing time is less than the overall sliding time, resetting the sliding start location as the sum of the sliding start location and the current sliding distance, and invoking the drawing recording module; and

a second processing module, adapted for drawing, at the sliding termination location, a sliding trace of a slide action existing in the last image frame on the condition that the drawing time is greater than or equal to the overall sliding time.

### BRIEF DESCRIPTION OF DRAWINGS

In order to describe the technical solution in the embodiments of the present invention clearer, the accompanying drawings illustrating the embodiments will be simply described. It is apparent that the following accompanying drawings only illustrate some embodiments of the present invention, and for those skilled in the art, other accompanying drawings may be obtained based on these accompanying drawings without inventive labors.

FIG. 1 is a flow chart of a method for drawing a sliding trace provided in Embodiment 1 of the present invention.

FIG. 2 is a flow chart of a method for drawing a sliding trace provided in Embodiment 2 of the present invention.

FIG. 3 is a schematic diagram illustrating a relationship between the current sliding distance and the drawing time provided in Embodiment 2 of the present invention.

FIG. 4 is a schematic diagram illustrating a first structure of a mobile terminal provided in Embodiment 3 of the present invention.

FIG. 5 is a schematic diagram illustrating a second structure of a mobile terminal provided in Embodiment 3 of the present invention.

FIG. 6 is a schematic diagram illustrating a third structure of a mobile terminal provided in Embodiment 3 of the present invention.

FIG. 7 is a schematic diagram illustrating a structure of a mobile terminal provided in Embodiment 4 of the present invention.

### DETAILED DESCRIPTION

The embodiments of the present invention provide a method and a mobile terminal for drawing a sliding trace.

To make objectives, technical solution and advantages of the present invention more apparent, the embodiments of the present invention will be further described in detail by reference to the accompanying drawings.

### Embodiment 1

Referring to FIG. 1, FIG. 1 is a flow chart of a method for drawing a sliding trace provided in Embodiment 1 of the present invention. In the method of this embodiment, the execution entity may be a mobile terminal, for example a tablet computer or a mobile phone, but it is not limited thereto, and more examples will not be provided in detail.

The method for drawing a sliding trace includes the followings:

Block S101: obtaining an overall sliding distance and overall sliding time from a sliding start location to a sliding termination location.

Block S102: drawing, at the sliding start location, a sliding trace in a current image frame and recording a current time point when the drawing of the current image frame is completed.

Block S103: obtaining drawing time from a drawing start time point to the current time point when the drawing of the current image frame is completed, and determining whether the drawing time is greater than or equal to the overall sliding time; on the condition that the drawing time is less than the overall sliding time, Block S104 is to be performed, and on the condition that the drawing time is greater than or equal to the overall sliding time, Block S105 is to be performed.

Block S104: drawing, at the sliding termination location, a sliding trace in the last image frame, on the condition that the drawing time is less than the overall sliding time, obtaining a current sliding distance according to the drawing time, the overall sliding time and the overall sliding distance, resetting the sliding start location as the sum of the sliding start location and the current sliding distance, and returning to Block S102.

Block S105: drawing, at the sliding termination location, a sliding trace in the last image frame.

Preferably, the process of obtaining the current sliding distance according to the drawing time, the overall sliding time and the overall sliding distance includes generating an inertia proportion according to the drawing time and the overall sliding time, and multiplying the inertia proportion by the overall sliding distance to obtain the current sliding distance.

Preferably, the process of generating an inertia proportion according to the drawing time and the overall sliding time includes dividing the drawing time by the overall sliding time to obtain a drawing proportion and deriving the inertia proportion from the drawing proportion according to the formula: the inertia proportion=(the drawing proportion−1)2*(2*the drawing proportion−1)+1.

Preferably, the process of obtaining an overall sliding distance and overall sliding time from a sliding start location to a sliding termination location includes obtaining an overall sliding distance and the overall sliding time of a user which slides from a sliding start location to a sliding termination location.

Preferably, the process of obtaining an overall sliding distance and the overall sliding time from a sliding start location to a sliding termination location includes obtaining an overall sliding distance and overall sliding time preset by the system from a sliding start location to a sliding termination location.

In this embodiment, firstly, obtain the overall sliding distance and the overall sliding time, draw a sliding trace in the current image frame at the sliding start location and record the current time point when the drawing of the current image frame is completed; on the condition that the drawing time is less than the overall sliding time, obtain a current sliding distance, reset the sliding start location as the sum of the sliding start location and the current sliding distance, repeatedly perform the drawing of subsequent image frames until the drawing time is greater than or equal to the overall sliding time, and draw a sliding trace in the last image frame at the sliding termination location. Compared with the method for achieving a sliding operation by using the system controls, the drawing time and sliding action in this embodiment can be customized and then be obtained by the mobile terminal, thus various sliding interactions can be implemented, thereby improving the degree of the user experience.

### Embodiment 2

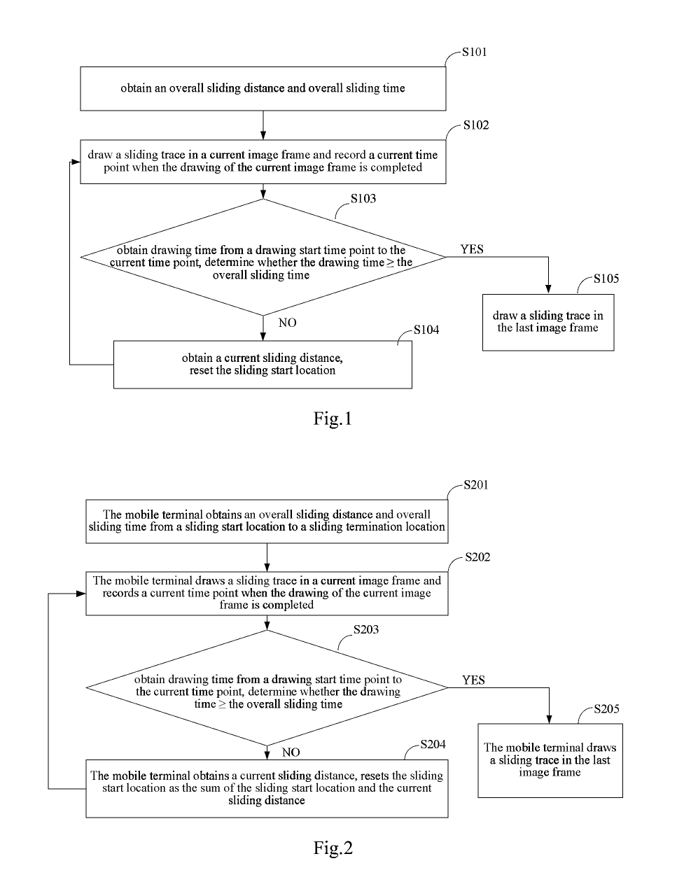

Referring to FIG. 2, FIG. 2 is a flow chart of a method for drawing a sliding trace provided in Embodiment 2 of the present invention. In the method of this embodiment, the execution entity may be a mobile terminal, for example a tablet computer or a mobile phone, but it is not limited thereto, and more examples will not be provided in detail.

The method for drawing a sliding trace includes the followings:

Block S201: a mobile terminal obtains an overall sliding distance and overall sliding time from a sliding start location to a sliding termination location.

In this block, when the user starts to slide on a touch screen of the mobile terminal, the mobile terminal may obtain an overall sliding distance and overall sliding time when the user slides from a sliding start location to a sliding termination location. Alternatively, when the system of the mobile terminal needs to play an animation, the mobile terminal may obtain the overall sliding distance and the overall sliding time preset by the system from a sliding start location to a sliding termination location.

In this embodiment, the sliding action of the user performed on the touch screen of the mobile terminal may be customized, and it is not limited to this embodiment. The mobile terminal may use the sliding distance and the sliding time as parameters to initialize a sliding distance calculator, and then obtain the overall sliding distance and the overall sliding time from a sliding start location to a sliding termination location via the sliding distance calculator. The sliding distance calculator may be implemented by logical programs.

Block S202: the mobile terminal draws at the sliding start location a sliding trace in a current image frame and records the current time point when the drawing of the current image frame is completed.

In this block, when the user starts to slide or when the system plays an animation, the mobile terminal draws images frame by frame. Specifically, when the user starts to slide or when the system plays an animation, the sliding distance calculator of the mobile terminal is activated, and meanwhile, the sliding distance calculator sends a start drawing massage to a drawing thread of the user interface of the mobile terminal, and the drawing thread of the user interface starts to draw images frame by frame upon receiving the start drawing massage.

For example, the mobile terminal starts to draw a sliding trace in a first image frame at the sliding start location, and the drawing start time point is denoted as starttime (such as 14:12:39:289 on Feb. 20, 2012), and when the drawing for the first image frame is completed, record the current time point which is denoted as currenttime when the first image frame is completed (such as 14:12:39:389 on Feb. 20, 2012).

It is noted that, the drawing start time point of the first image frame may be the same as the sliding start time point, or the difference between the drawing start time point of the first image frame and the sliding start time point is made as small as possible, as such, the sliding trace can be drawn as soon as the sliding operation starts, thereby reducing a delay of drawing the sliding trace. For example, when the user starts to slide on the touch screen of the mobile terminal, the mobile terminal may perform an operation of drawing the sliding trace in the current image frame at the sliding start location, and thus the drawing start time point of the first image frame may be consistent with the sliding start time point.

Block S203: the mobile terminal obtains drawing time from the drawing start time point to the current time point when the drawing of the current image frame is completed, and determines whether the drawing time is greater than or equal to the overall sliding time; on the condition that the drawing time is less than the overall sliding time, Block S204 is to be performed, and on the condition that the drawing time is greater than or equal to the overall sliding time, Block S205 is to be performed.

In this block, when the mobile terminal completes the drawing for the first image frame, the mobile terminal invokes an interface function of the sliding distance calculator to obtain the current sliding distance. The sliding distance calculator obtains the drawing time (i.e., the drawing time from the starttime to the currenttime, or referred to as the sliding time from the starttime to the currenttime) according to the difference between the drawing start time point starttime and the current time point currenttime when the first image frame is completed. Then, the mobile terminal determines whether the drawing time is greater than or equal to the overall sliding time, and performs the corresponding process according to the determination result.

Block S204: the mobile terminal obtains a current sliding distance according to the drawing time, the overall sliding time and the overall sliding distance, resets the sliding start location as the sum of the sliding start location and the current sliding distance, and returns to Block S202.

On the condition that the drawing time is less than the overall sliding time, the sliding distance calculator of the mobile terminal obtains the current sliding distance according to the drawing time, the overall sliding time and the overall sliding distance.

Specifically, the sliding distance calculator of the mobile terminal may derive the current sliding distance according to formulas (1) and (2):

the drawing proportion=the drawing time/the overall sliding time (1)

the current sliding distance=the overall sliding time*the drawing proportion (2)

Since both of the process for drawing images and the process for calculating the current sliding distance are time consuming, preferably, in order to make the sliding operation exhibit a better fluency and real experience, an inertia formula is additionally used in the process for calculating the current sliding distance in this embodiment.

Specifically, the mobile terminal generates an inertia proportion according to the drawing time and the overall sliding time; and the mobile terminal multiplies the inertia proportion by the overall sliding distance to obtain the current sliding distance.

The sliding distance calculator of the mobile terminal generates the inertia proportion according to the drawing time and the overall sliding time by using formulas (1) and (3), and the sliding distance calculator generates the current sliding distance according to the overall sliding time and the inertia proportion by using formula (4). The formulas are specifically as follows:

the drawing proportion=the drawing time/the overall sliding time (1)

the inertia proportion=(the drawing proportion−1)²*(2*the drawing proportion-1)+1 (3)

the current sliding distance=the overall sliding time*the inertia proportion (4)

After obtaining the current sliding distance, the mobile terminal resets the sliding start location as the sum of the sliding start location and the current sliding distance, and returns to Block S202 to repeatedly perform subsequent processes to make drawings for other image frames that follow the first image frame. For example, provided that the sliding start location is denoted as startX and the current sliding distance is 40 pixels, the new sliding start location may be reset as (startX+40 pixels), and the mobile terminal returns to Block S202 to draw a sliding trace for the second image frame. When the mobile terminal draws the sliding trace for the second image frame, the sliding trace for the first image frame is erased first and then the sliding trace for the second image frame is drawn. The drawing processes for other image frames are similar to that of the second image frame, that is, before the sliding trace for the current image frame is drawn, the sliding trace for the previous image frame is erased. Repeat this process to sequentially draw the sliding traces for the subsequent image frames until the drawing time is greater than or equal to the overall sliding time.

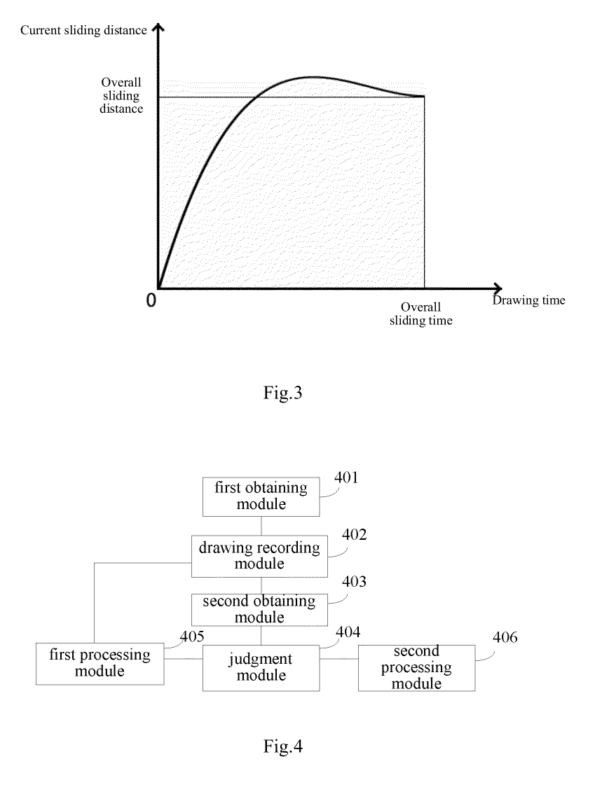

In this embodiment, the relationship between the sliding distance and the drawing time is as shown in FIG. 3. FIG. 3 is a schematic diagram illustrating a relationship between the current sliding distance and the drawing time provided in Embodiment 2 of the present invention. As can be seen from FIG. 3, when the current sliding distance is less than the overall sliding distance, the inertia proportion is less than 1; when the current sliding distance is equal to the overall sliding distance, the inertia proportion is equal to 1; and when the current sliding distance is greater than the overall sliding distance, the inertia proportion is greater than 1.

Block S205: the mobile terminal draws a sliding trace in the last image frame at the sliding termination location.

When the drawing time is greater than or equal to the overall sliding time, the mobile terminal draws the sliding trace in the last image frame at the sliding termination location, and completes the entire drawing process.

In this embodiment, firstly, obtain the overall sliding distance and the overall sliding time, draw a sliding trace in the current image frame at the sliding start location and record the current time point when the drawing of the current image frame is completed; on the condition that the drawing time is less than the overall sliding time, obtain a current sliding distance, reset the sliding start location as the sum of the sliding start location and the current sliding distance, repeatedly perform the drawing of subsequent image frames until the drawing time is greater than or equal to the overall sliding time, and draw a sliding trace in the last image frame at the sliding termination location. Compared with the method for achieving a sliding operation by using the system controls, the drawing time and sliding action in this embodiment can be customized and then be obtained by the mobile terminal, thus implementation of various sliding interactions can be achieved, thereby improving the degree of the user experience.

In addition, since the inertia formula is additionally used in the process for calculating the current sliding distance, the sliding operation performed by the mobile terminal exhibits a better fluency and real experience, thereby improving the degree of the user experience.

### Embodiment 3

Referring to FIG. 4, FIG. 4 is a schematic diagram illustrating a first structure of a mobile terminal provided in Embodiment 3 of the present invention. The mobile terminal may be, for example, a tablet computer or a mobile phone, but it is not limited thereto, and more examples will not be provided in detail.

The mobile terminal includes the followings:

A first obtaining module 401, adapted for obtaining an overall sliding distance and overall sliding time from a sliding start location to a sliding termination location.

A drawing recording module 402, adapted for drawing, at the sliding start location, a sliding trace in a current image frame and recording a current time point when the drawing of the current image frame is completed.

A second obtaining module 403, adapted for obtaining drawing time from a drawing start time point to the current time point when the drawing of the current image frame is completed.

A determination module 404, adapted for determining whether the drawing time is greater than or equal to the overall sliding time.

A first processing module 405, adapted for, on the condition that the determination module 404 determines that the drawing time is less than the overall sliding time, obtaining the current sliding distance according to the drawing time, the overall sliding time and the overall sliding distance, resetting the sliding start location as the sum of the sliding start location and the current sliding distance, and invoking the drawing recording module 402.

A second processing module 406, adapted for drawing, at the sliding termination location, a sliding trace in the last image frame on the condition that the determination module 404 determines that the drawing time is greater than or equal to the overall sliding time.

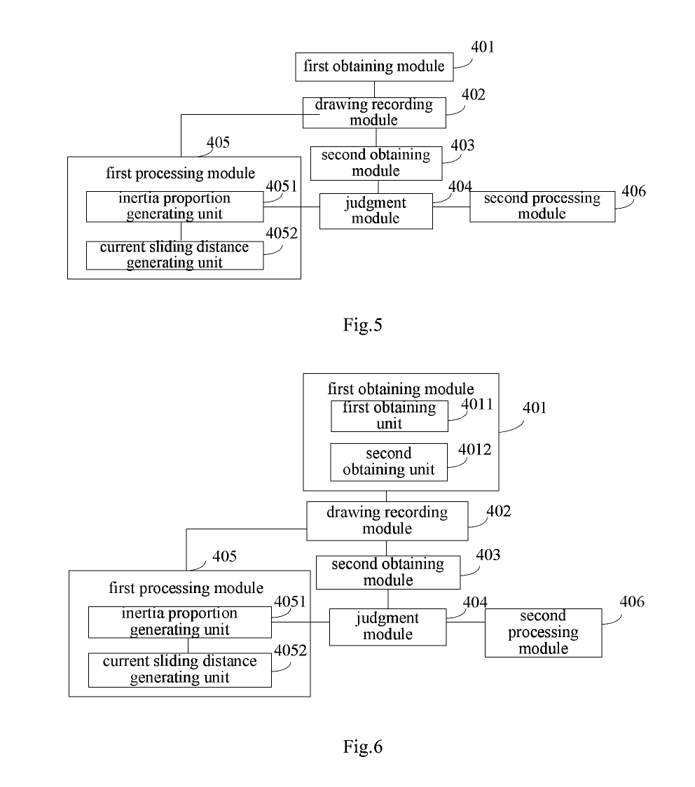

The first processing module 405 includes an inertia proportion generating unit 4051 and a current sliding distance generating unit 4052, as shown in FIG. 5. FIG. 5 is a schematic diagram illustrating a second structure of a mobile terminal provided in Embodiment 3 of the present invention.

The inertia proportion generating unit 4051 is adapted for generating an inertia proportion according to the drawing time and the overall sliding time.

The current sliding distance generating unit 4052 is adapted for multiplying the inertia proportion by the overall sliding distance to obtain the current sliding distance.

The inertia proportion generating unit 4051 includes the followings:

A first generating subunit, adapted for dividing the drawing time by the overall sliding time to obtain a drawing proportion.

A second generating subunit, adapted for deriving the inertia proportion from the drawing proportion according to the formula: the inertia proportion=(the drawing proportion−1)²*(2*the drawing proportion−1)+1.

On the basis of the above implementation, as shown in FIG. 6, FIG. 6 is a schematic diagram illustrating a third structure of a mobile terminal provided in Embodiment 3 of the present invention, and the first obtaining module 401 includes a first obtaining unit 4011, adapted for obtaining the overall sliding distance and overall sliding time of a user which slides from the sliding start location to the sliding termination location.

Alternatively, the first obtaining module 401 includes a second obtaining unit 4012 adapted for obtaining the overall sliding distance and the overall sliding time from the sliding start location to the sliding termination location that is preset by the system.

In this embodiment, firstly, the mobile terminal obtains the overall sliding distance and the overall sliding time, draws a sliding trace in the current image frame at the sliding start location and records the current time point when the drawing of the current image frame is completed; on the condition that the drawing time is less than the overall sliding time, it obtains a current sliding distance, resets the sliding start location as the sum of the sliding start location and the current sliding distance, repeatedly performs the drawing of subsequent image frames until the drawing time is greater than or equal to the overall sliding time, and draws a sliding trace in the last image frame at the sliding termination location. Compared with methods for achieving a slid by using system controls, the drawing time and sliding action in this embodiment can be customized and then be obtained by the mobile terminal, thus implementation of various sliding interactions can be achieved, thereby improving the user experience.

In addition, since the inertia formula is additionally used in the process for calculating the current sliding distance, the sliding operation performed by the mobile terminal exhibits a better fluency and real experience, thereby improving the degree of the user experience.

### Embodiment 4

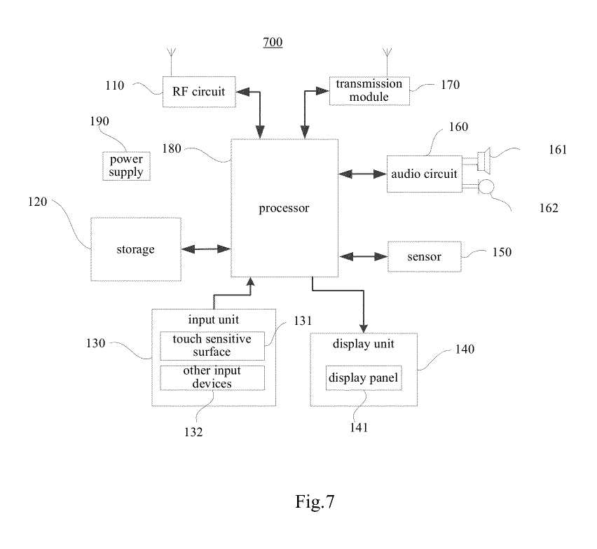

Referring to FIG. 7, this embodiment provides a mobile terminal. FIG. 7 is a schematic diagram illustrating a structure of a mobile terminal having a touch sensitive surface, and this mobile terminal can be used to implement the method for drawing a sliding trace described in the above embodiments.

The mobile terminal 700 may include a RF (Radio Frequency) circuit 110, a storage 120 including one or more computer-readable medium, an input unit 130, a display unit 140, a sensor 150, an audio circuit 160, a transmission module 170, a processor 180 including one or more processing cores, and a power supply 190 etc. Those skilled in the art could understand that the mobile terminal is not limited to the structure of the mobile terminal shown in FIG. 7, and the mobile terminal may include more or less components, or include combinations of some components, or include different component configurations.

The RF circuit 110 may be used to transmit and receive information, or receive and send signals during a phone call. Specifically, after receiving downlink information from a base station, the RF circuit 110 sends this information to one or more processors 180 to process this information, and in addition, sends data related to the uplink to the base station. Generally, the RF circuit 110 may include, but not limited to, an antenna, at least one amplifier, a tuner, one or more oscillators, a subscriber identity module (SIM) card, a transceiver, a coupler, a Low Noise Amplifier (LNA), a duplexer and etc. In addition, the RF circuit 110 may communicate with other devices though wireless communication and a network. The wireless communication may be performed under any communication standard or protocol, which includes but not limited to Global System of Mobile communication (GSM), General Packet Radio Service (GPRS), Code Division Multiple Access (CDMA), Wideband Code Division Multiple Access (WCDMA), Long Term Evolution (LTE), Email, Short Messaging Service (SMS) and etc.

The Storage 120 may be used to store software programs and modules, such as software programs and modules corresponding to the mobile terminal in Embodiment 3. The processor 180 runs the software programs and modules stored in the storage 120 to perform various functional applications and data processing, such as drawing the sliding trace etc. The Storage 120 may mainly includes a program storage area and a data storage area, and the program storage area may store the operating system, application programs for at least one function (such as an audio play function, an image play function or the like) and so on, the data storage area may store the data (such as audio data, a phone directory, or the like) which is created according to the usage of the mobile terminal 700 and so on. In addition, the storage 120 may include a high speed random access memory, or a nonvolatile memory, such as at least one disk storage device, a flash device or other nonvolatile solid-state memory devices. Correspondingly, the storage 120 may also include a storage controller to provide access from the processor 180 and the input unit 130 to the storage 120.

The input unit 130 may be used to receive the input digit or character information, and generate signal inputs of a keyboard, a mouse, an operating bar, an optical or trace ball related to user configurations and functional controls. Specifically, the input unit 130 may include a touch sensitive surface 131 and other input device 132. The touch sensitive surface 131, also called a touch screen or a touch panel, may collect touch operations of the user on or near the touch sensitive surface (for example, the user uses any suitable objects such as a finger, a touch pen or the like to operate on the touch sensitive surface 131 or near the touch sensitive surface 131), and actuate corresponding connected devices according to preset manners. Optionally, the touch sensitive surface 131 may include two parts: a touch detecting device and a touch controller. The touch detecting device detects the touch orientation of the user, detects a signal triggered by the touch operation, and transmits this signal to the touch controller. The touch controller receives touch information from the touch detecting device, converts this information to touch point coordinates, sends the touch point coordinates to the processor 180 and receives a command from the processor 180 and executes this command. In addition, the touch sensitive surface 131 may be implemented in various manners, such as using resistances, capacitances, infrared ray and surface acoustic waves etc. In addition to the touch sensitive surface 131, the input unit 130 may also include other input devices 132 which specifically may include but not limited to one or more of a physical keyboard, functional keys (such as a volume control button, a switch button, etc.,), a trace ball, a mouse, an operating bar and etc.

The display unit 140 may display information input by the user or that provided for the user as well as various graphic user interfaces of the mobile terminal 700. These graphic user interfaces may be consist of graphs, texts, icons, videos and any combination thereof. The display unit 140 may include a display panel 141, and optionally, the display panel 141 may be configured in a manner such as Liquid Crystal Display (LCD), Organic Light-Emitting Diode (OLED) or etc. Further, the touch sensitive surface 131 may cover the display panel 141, and when the touch sensitive surface 131 detects a touch operation on it of near it, the touch sensitive surface 131 sends information to the processor 180 to determine the type of this touch event, and then the processor 180 provides corresponding visual output on the display panel 141 according to the type of this touch event. Although in FIG. 7, the touch sensitive surface 131 and the display panel 141 act as two individual components to implement the input and output functions, in some embodiment, the touch sensitive surface 131 and the display panel 141 may be integrated into one single body to implement the input and output functions.

The mobile terminal 700 may also include at least one sensor 150, such as an optical sensor, a motion sensor and other sensors. Specifically, the optical sensor may include an ambient light sensor and a proximity sensor, where the ambient light sensor may adjust the brightness of the display panel 141 according to the ambient lighting, and the proximity sensor may turn off the display panel 141 and/or backlight when the mobile terminal 700 is moved near to the ear. As one kind of the motion sensor, a gravity acceleration sensor may detect acceleration values in various directions (generally, on three axes), detect the value and direction of the gravity when the mobile terminal is in a static state, be used in applications for recognizing mobile phone postures (such as an application for switching screen anyway, related games, magnetometer posture calibration), and be used in functions related to vibration reorganization (such as pedometer, knocking) and etc. The mobile terminal 700 may also be configured with other sensors such as a gyroscope, a barometer, a hygrometer, a thermometer, an infrared sensor, etc., and the details are not described herein.

The audio circuit 160, loudspeaker 161 and microphone 162 may provide audio interfaces between the user and the mobile terminal 700. The audio circuit 160 may transmit electrical signals converted from the audio data to the loudspeaker 161, and the loudspeaker 161 converts the electrical signals into sound signals and outputs them. On the other hand, the microphone 162 converts collected sound signals into electrical signals, the audio circuit 160 receives such electrical signals, converts these signals into audio data, and input these audio data into the processor 180. The processor 180 processes the received audio data, and sends the processed audio data, for example, to another mobile terminal via the RF circuit 119, or sends the processed audio data to the storage 120 for further processing. The audio circuit 160 may also includes a receiver jack, in order to provide communications between peripheral headsets and the mobile terminal 700.

The mobile terminal 700 may help the user to transmit and receive Emails, browse WebPages and visit streaming media via the transmission module 170. The mobile terminal 700 provide wireless or cable internet access for users. Although FIG. 7 shows the transmission module 170, it can be understood that the transmission module 170 is not necessary to be included in the mobile terminal, and may be omitted as required without changing the substantial scope of this invention.

The processor 180 is the control center of the mobile terminal 700, uses various interfaces and lines to connect respective parts of the entire mobile phone, and performs various functions and processes data by running or executing software programs and/or modules stored in the storage 120 and invoking data stored in the storage 120, thereby wholly monitoring the mobile phone. Optionally, the processor 180 may include one or more processing cores. Preferably, the processor 180 may be an integration of an application processor and a modem processor, and the application processor mainly processes the operating system, user interfaces and application programs etc., and the modem processor mainly processes the wireless communications. It can be understood that, the above modem processor may not be integrated into the processor 180.

The mobile terminal 700 may also include a power supply 190 (such as a battery) for powering various components. Preferably, the power supply may be logically connected to the processor 180 through a power supply management system, thereby achieving functions such as management for charging, discharging and power consumption etc., through the power supply management system. The power supply 190 may also include any assembly of one or more direct current or alternating current power supply, a recharging system, a power supply fault detection circuit, a power converter or inverter, a power status indicator and the like.

Although not shown, the mobile terminal 700 may also include a camera, a Bluetooth modules and etc., and the details are not described herein. Specifically, in this embodiment, the display unit of the mobile terminal is a touch screen display, and the mobile terminal also includes a storage and one or more programs, and the one or more programs are stored in the storage and configured to enable one or more processors to perform the one or more programs which include instructions for performing the following operations:

A) obtaining an overall sliding distance and overall sliding time from a sliding start location to a sliding termination location;

B) drawing, at the sliding start location, a sliding trace in a current image frame and recording a current time point when the drawing of the current image frame is completed;

C) obtaining drawing time from a drawing start time point to the current time point when the drawing of the current image frame is completed, and determining whether the drawing time is greater than or equal to the overall sliding time; on the condition that the drawing time is less than the overall sliding time, performing step D, and on the condition that the drawing time is greater than or equal to the overall sliding time, performing step E;

D) obtaining a current sliding distance according to the drawing time, the overall sliding time and the overall sliding distance, resetting the sliding start location as the sum of the sliding start location and the current sliding distance, and returning to step B; and

E) drawing, at the sliding termination location, a sliding trace in the last image frame.

Assuming that the above implementation is a first possible implementation, in a second possible implementation provided based on the first possible implementation, the storage of the mobile terminal may also include instructions for performing the following operations:

generating an inertia proportion according to the drawing time and the overall sliding time; and

multiplying the inertia proportion by the overall sliding distance to obtain the current sliding distance.

In a third possible implementation provided based on the first possible implementation, the storage of the mobile terminal may also include instructions for performing the following operations:

dividing the drawing time by the overall sliding time to obtain a drawing proportion;

deriving the inertia proportion from the drawing proportion according to the follows:

the inertia proportion=(the drawing proportion−1)²*(2*the drawing proportion−1)+1.

In a fourth possible implementation provided based on the first, second or third possible implementation, the storage of the mobile terminal may also include instructions for performing the following operations:

obtaining an overall sliding distance and overall sliding time of a user which slides from the sliding start location to the sliding termination location.

In a fifth possible implementation provided based on the first, second or third possible implementation, the storage of the mobile terminal may also include instructions for performing the following operations:

obtaining a system-preset overall sliding distance and overall sliding time from a sliding start location to a sliding termination location.

To sum up, the mobile terminal in this embodiment firstly obtains the overall sliding distance and the overall sliding time, draws a sliding trace in the current image frame at the sliding start location and records the current time point when the drawing of the current image frame is completed; on the condition that the drawing time is less than the overall sliding time, it obtains a current sliding distance, resets the sliding start location as the sum of the sliding start location and the current sliding distance, repeatedly performs the drawing of subsequent image frames until the drawing time is greater than or equal to the overall sliding time, and draws a sliding trace in the last image frame at the sliding termination location. Compared with methods for achieving a slid by using system controls, the drawing time and sliding action in this embodiment can be customized and then be obtained by the mobile terminal, thus implementation of various sliding interactions can be achieved, thereby improving the user experience.

In addition, since the inertia formula is additionally used in the process for calculating the current sliding distance, the sliding operation performed by the mobile terminal exhibits a better fluency and real experience, thereby improving the degree of the user experience.

### Embodiment 5

This embodiment provides a computer-readable storage medium. The computer-readable storage medium may be the computer-readable storage medium included in the storage of the above embodiment, or may be a separate computer-readable storage medium which is not assembly into the mobile terminal. The computer-readable storage medium includes one or more programs which are used by one or more processors to perform a method for drawing a sliding trace. The method includes:

A) obtaining an overall sliding distance and overall sliding time from a sliding start location to a sliding termination location;

B) drawing, at the sliding start location, a sliding trace in a current image frame and recording a current time point when the drawing of the current image frame is completed;

C) obtaining drawing time from a drawing start time point to the current time point when the drawing of the current image frame is completed, and determining whether the drawing time is greater than or equal to the overall sliding time; on the condition that the drawing time is less than the overall sliding time, performing step D, and on the condition that the drawing time is greater than or equal to the overall sliding time, performing step E;

D) obtaining a current sliding distance according to the drawing time, the overall sliding time and the overall sliding distance, resetting the sliding start location as the sum of the sliding start location and the current sliding distance, and returning to step B; and

E) drawing, at the sliding termination location, a sliding trace in the last image frame.

Assuming that the above implementation is a first possible implementation, in a second possible implementation provided based on the first possible implementation, the storage of the mobile terminal may also include instructions for performing the following operations:

generating an inertia proportion according to the drawing time and the overall sliding time; and

multiplying the inertia proportion by the overall sliding distance to obtain the current sliding distance.

In a third possible implementation provided based on the first possible implementation, the storage of the mobile terminal may also include instructions for performing the following operations:

dividing the drawing time by the overall sliding time to obtain a drawing proportion;

deriving the inertia proportion from the drawing proportion according to the follows:

the inertia proportion=(the drawing proportion−1)²*(2*the drawing proportion−1)+1.

In a fourth possible implementation provided based on the first, second or third possible implementation, the storage of the mobile terminal may also include instructions for performing the following operations:

obtaining an overall sliding distance and overall sliding time of a user which slides from the sliding start location to the sliding termination location.

In a fifth possible implementation provided based on the first, second or third possible implementation, the storage of the mobile terminal may also include instructions for performing the following operations:

obtaining a system-preset overall sliding distance and overall sliding time from a sliding start location to a sliding termination location.

The computer-readable medium in this embodiment firstly obtains the overall sliding distance and the overall sliding time, draws a sliding trace in the current image frame at the sliding start location and records the current time point when the drawing of the current image frame is completed; on the condition that the drawing time is less than the overall sliding time, it obtains a current sliding distance, resets the sliding start location as the sum of the sliding start location and the current sliding distance, repeatedly performs the drawing of subsequent image frames until the drawing time is greater than or equal to the overall sliding time, and draws a sliding trace in the last image frame at the sliding termination location. Compared with methods for achieving a slid by using system controls, the drawing time and sliding action in this embodiment can be customized and then be obtained by the mobile terminal, thus implementation of various sliding interactions can be achieved, thereby improving the user experience.

In addition, since the inertia formula is additionally used in the process for calculating the current sliding distance, the sliding operation performed by the mobile terminal exhibits a better fluency and real experience, thereby improving the degree of the user experience.

### Embodiment 6

This embodiment provides a graphic user interface. The graphic user interface is used in the mobile terminal, and the mobile terminal includes a touch screen display, a storage and one or more processors for performing one or more programs. The graphic user interface includes:

A) obtaining an overall sliding distance and overall sliding time from a sliding start location to a sliding termination location;

B) drawing, at the sliding start location, a sliding trace in a current image frame and recording a current time point when the drawing of the current image frame is completed;

C) obtaining drawing time from a drawing start time point to the current time point when the drawing of the current image frame is completed, and determining whether the drawing time is greater than or equal to the overall sliding time; on the condition that the drawing time is less than the overall sliding time, performing step D, and on the condition that the drawing time is greater than or equal to the overall sliding time, performing step E;

D) obtaining a current sliding distance according to the drawing time, the overall sliding time and the overall sliding distance, resetting the sliding start location as the sum of the sliding start location and the current sliding distance, and returning to step B; and

E) drawing, at the sliding termination location, a sliding trace in the last image frame.

The graphic user interface in this embodiment firstly obtains the overall sliding distance and the overall sliding time, draws a sliding trace in the current image frame at the sliding start location and records the current time point when the drawing of the current image frame is completed; on the condition that the drawing time is less than the overall sliding time, it obtains a current sliding distance, resets the sliding start location as the sum of the sliding start location and the current sliding distance, repeatedly performs the drawing of subsequent image frames until the drawing time is greater than or equal to the overall sliding time, and draws a sliding trace in the last image frame at the sliding termination location. Compared with methods for achieving a slid by using system controls, the drawing time and sliding action in this embodiment can be customized and then be obtained by the mobile terminal, thus implementation of various sliding interactions can be achieved, thereby improving the user experience.

In addition, since the inertia formula is additionally used in the process for calculating the current sliding distance, the sliding operation performed by the mobile terminal exhibits a better fluency and real experience, thereby improving the degree of the user experience.

It is noted that, the embodiments in this description are described in a progressive manner, each embodiment is mainly focused on the differences from other embodiments, and the same or similar parts of various embodiments may be commonly used in these embodiments. For the embodiments of the device, since they are similar to the embodiments of the method, they are only simply described, and the corresponding description may be referred to the description of the embodiments of the method.

It is noted that, in this specification, the relationship terms such as first, second, etc., are used only for the purpose of distinguishing one entity or operation from another one, but not to require or imply that these entities and operations have any of such actual relationship or order. Furthermore, the terms “include”, “comprise” and any other variant are intended to cover the cases of non-excludable comprising, thus the processes, methods, articles or devices including a series of elements include not only those elements, but also other elements which are not explicitly listed herein, or the elements inherently included in the processes, methods, articles or devices. Unless there are further limitations, the element defined by the clause “including one . . . ” does not exclude the case that the processes, methods, articles or devices including the above element also include other identical elements.

Those skilled in the art could be understand that all or a part of the above embodiments may be completed by using hardware, or be implemented by using a program which instructs the hardware to complete these embodiments. The program may be stored in a computer-readable storage medium, and the storage medium may be a read only memory, a magnetic disc or an optical disc.

The forgoing is only preferred embodiments of the present invention, and is not intended to limit the present invention. Any modifications, equivalents, improvements and the like made within the spirit and principle of the present application should be encompassed in the protection scope of the present application.

1. A method for drawing a sliding trace, characterized by comprising:
A) obtaining an overall sliding distance and overall sliding time from a sliding start location to a sliding termination location;
B) drawing, at the sliding start location, a sliding trace in a current image frame and recording a current time point when the drawing of the current image frame is completed;
C) obtaining drawing time from a drawing start time point to the current time point when the drawing of the current image frame is completed, and determining whether the drawing time is greater than or equal to the overall sliding time; on the condition that the drawing time is less than the overall sliding time, performing step D, and on the condition that the drawing time is greater than or equal to the overall sliding time, performing step E;
D) obtaining a current sliding distance according to the drawing time, the overall sliding time and the overall sliding distance, resetting the sliding start location as the sum of the sliding start location and the current sliding distance, and returning to step B; and
E) drawing, at the sliding termination location, a sliding trace in the last image frame.

2. The method according to claim 1, characterized in that, a process of obtaining a current sliding distance according to the drawing time, the overall sliding time and the overall sliding distance comprises:
generating an inertia proportion according to the drawing time and the overall sliding time; and
multiplying the inertia proportion by the overall sliding distance to obtain the current sliding distance.

3. The method according to claim 2, characterized in that, a process of generating an inertia proportion according to the drawing time and the overall sliding time comprises:
dividing the drawing time by the overall sliding time to obtain a drawing proportion;
deriving the inertia proportion from the drawing proportion according to the follows:
the inertia proportion=(the drawing proportion−1)²*(2*the drawing proportion−1)+1.

4. The method according to claim 1, characterized in that, a process of obtaining the overall sliding distance and the overall sliding time from the sliding start location to the sliding termination location comprises:
obtaining an overall sliding distance and overall sliding time of a user which slides from the sliding start location to the sliding termination location.

5. The method according to claim 1, characterized in that, a process of obtaining the overall sliding distance and the overall sliding time from the sliding start location to the sliding termination location comprises:
obtaining a system-preset overall sliding distance and overall sliding time from a sliding start location to a sliding termination location.

6. (canceled)

7. (canceled)

8. (canceled)

10. (canceled)

11. A mobile terminal, characterized in that, the mobile terminal comprises a touch screen display, one or more processors, a storage and one or more programs, wherein the one or more programs are stored in the storage and are configured to be performed by the one or more processors, and the one or more programs comprise instructions for performing the following operations:
A) obtaining an overall sliding distance and overall sliding time from a sliding start location to a sliding termination location;
B) drawing, at the sliding start location, a sliding trace in a current image frame and recording a current time point when the drawing of the current image frame is completed;
C) obtaining drawing time from a drawing start time point to the current time point when the drawing of the current image frame is completed, and determining whether the drawing time is greater than or equal to the overall sliding time; on the condition that the drawing time is less than the overall sliding time, performing step D, and on the condition that the drawing time is greater than or equal to the overall sliding time, performing step E;
D) obtaining a current sliding distance according to the drawing time, the overall sliding time and the overall sliding distance, resetting the sliding start location as the sum of the sliding start location and the current sliding distance, and returning to step B; and
E) drawing, at the sliding termination location, a sliding trace in the last image frame.

12. The mobile terminal according to claim 11, characterized by, comprising instructions for performing the following operations:
generating an inertia proportion according to the drawing time and the overall sliding time; and
multiplying the inertia proportion by the overall sliding distance to obtain the current sliding distance.

13. The mobile terminal according to claim 12, characterized by, comprising instructions for performing the following operations:
dividing the drawing time by the overall sliding time to obtain a drawing proportion;
deriving the inertia proportion from the drawing proportion according to the follows:
the inertia proportion=(the drawing proportion−1)²*(2*the drawing proportion−1)+1.

14. The mobile terminal according to claim 11, characterized by, comprising instructions for performing the following operations:
obtaining an overall sliding distance and overall sliding time of a user which slides from the sliding start location to the sliding termination location.

15. The mobile terminal according to claim 11, characterized by, comprising instructions for performing the following operations:
obtaining a system-preset overall sliding distance and overall sliding time from a sliding start location to a sliding termination location.

16. A computer-readable storage medium, characterized in that, the computer-readable storage medium stores one or more programs, and the one or more programs are performed by one or more processors to achieve a method for controlling sliding, and the method comprises:
A) obtaining an overall sliding distance and overall sliding time from a sliding start location to a sliding termination location;
B) drawing, at the sliding start location, a sliding trace in a current image frame and recording a current time point when the drawing of the current image frame is completed;
C) obtaining drawing time from a drawing start time point to the current time point when the drawing of the current image frame is completed, and determining whether the drawing time is greater than or equal to the overall sliding time; on the condition that the drawing time is less than the overall sliding time, performing step D, and on the condition that the drawing time is greater than or equal to the overall sliding time, performing step E;
D) obtaining a current sliding distance according to the drawing time, the overall sliding time and the overall sliding distance, resetting the sliding start location as the sum of the sliding start location and the current sliding distance, and returning to step B; and
E) drawing, at the sliding termination location, a sliding trace in the last image frame.

17. The computer-readable storage medium according to claim 16, characterized in that, a process of obtaining a current sliding distance according to the drawing time, the overall sliding time and the overall sliding distance comprises:
generating an inertia proportion according to the drawing time and the overall sliding time; and
multiplying the inertia proportion by the overall sliding distance to obtain the current sliding distance.

18. The computer-readable storage medium according to claim 17, characterized in that, a process of generating an inertia proportion according to the drawing time and the overall sliding time comprises:
dividing the drawing time by the overall sliding time to obtain a drawing proportion;
deriving the inertia proportion from the drawing proportion according to the follows:
the inertia proportion=(the drawing proportion−1)²*(2*the drawing proportion−1)+1.

19. The computer-readable storage medium according to claim 16, characterized in that, a process of obtaining the overall sliding distance and the overall sliding time from the sliding start location to the sliding termination location comprises:
obtaining an overall sliding distance and overall sliding time of a user which slides from the sliding start location to the sliding termination location.

20. The computer-readable storage medium according to claim 16, characterized in that, a process of obtaining the overall sliding distance and the overall sliding time from the sliding start location to the sliding termination location comprises:
obtaining a system-preset overall sliding distance and overall sliding time from a sliding start location to a sliding termination location.

21. (canceled)
